(19) United States
(12) Patent Application Publication
(10) Pub. No.: US 2017/0173813 A1
(43) Pub. Date: Jun. 22, 2017

(54) MEAT SLICER WITH IMPROVED SAFETY FEATURE

(71) Applicant: BLUE SKY INNOVATION GROUP, INC., Avon, OH (US)

(72) Inventors: Jeffrey W. Palese, North Ridgeville, OH (US); Joseph J. Smith, North Ridgeville, OH (US)

(21) Appl. No.: 15/381,341

(22) Filed: Dec. 16, 2016

Related U.S. Application Data
(60) Provisional application No. 62/270,625, filed on Dec. 22, 2015.

(51) Int. Cl. B26D 7/26; B26D 3/08; B26D 7/06; B26D 1/24

(52) U.S. Cl. CPC B26D 7/2621; B26D 1/24; B26D 3/08; B26D 7/0641; B26D 2210/02; B02C 18/301

(57) ABSTRACT

An apparatus for slicing food products includes a housing including an inlet, for receiving food products to be sliced and an outlet for discharging the sliced food product. A primary shaft is supported in the housing for rotation about a primary axis. The primary shaft carries a plurality of slicing blades that are rotatable with the primary shaft about the primary axis. A secondary shaft is supported in the housing for rotation about a secondary axis. The secondary shaft carries a plurality of slicing blades that are rotatable with the secondary shaft about the secondary axis. The primary and secondary shafts are positioned in the housing in a spaced and parallel manner so that the slicing blades are arranged in slicing pairs. Each slicing pair includes one slicing blade on the primary shaft and one slicing blade on the secondary shaft. The slicing blades in each slicing pair have peripheral portions that overlap each other. The apparatus further includes at least one biasing member for biasing the overlapping peripheral portions of the slicing blades of each slicing pair against each other.

### RELATED APPLICATION

This application claims the benefit of U.S. Provisional Application Ser. No. 62/270,625, which was filed on Dec. 22, 2015, the disclosure of which is hereby incorporated by reference in its entirety.

### TECHNICAL FIELD

This invention relates to a food processing apparatus. More specifically, this invention relates to a slicer attachment for a meat grinder that includes improved safety features.

### BACKGROUND OF THE INVENTION

Grinders are food processing appliances that are used to grind, chop or mince food products, such as meat, fish, poultry, vegetables, or similar foods. The most common food products processed in a grinder are meat products, such as beef, pork, venison, etc. A known food processing apparatus in the form of a meat grinder 10 is illustrated in FIG. 1. The meat grinder 10 includes a grinder head 12 and a drive unit 14, such as an electric motor. The electric motor drive unit could be replaced with a hand crank. The grinder head 12 includes an inlet or chute 16, into which raw meat is fed, and an outlet. 18 from which the ground or minced meat is discharged. The grinder head 12 includes a housing 20 that houses typical grinder components, such as an auger/screw conveyor, a rotating knife including mincing blades, and a fixed hole plate or die. These typical components are shown, for example, in U.S. Pat. No. 7,207,510 B2, issued Apr. 24, 2007, the disclosure of which is hereby incorporated by reference in its entirety.

The grinder head 12 is connectable to the drive unit 14 via a connection to a output 22 of the drive unit. The output 22 includes an output coupling 24 for receiving a mating input coupling 26 of the grinder head 12. The input coupling 26 is received in the output coupling 24 and locked in place by a locking member 28, such as a thumb screw, to mount the grinder head 12 on the drive unit 14. When the grinder head. 12 is coupled to the drive unit 14, an output shaft (not shown) of the drive unit engages and couples with an input shaft of the grinder head so that operation of the drive unit, causes rotation of the output shaft, which imparts rotation to the input shaft, thus operating the grinder head. The output coupling 24 permits the drive unit 14 to be coupled with and drive any device or apparatus having a mating input coupling 26.

### SUMMARY

According to one aspect, an apparatus for for slicing food products includes a housing including an inlet flan receiving food products to be sliced and an outlet for discharging the sliced food product. A primary shaft is supported in the housing for rotation about a primary axis. The primary shaft carries a plurality of slicing blades that are rotatable with the primary shaft about the primary axis. A secondary shaft is supported in the housing for rotation about a secondary axis. The secondary shaft carries a plurality of slicing blades that are rotatable with the secondary shaft about the secondary axis. The primary and secondary shafts are positioned in the housing in a spaced and parallel manner so that the slicing blades are arranged in slicing pairs. Each slicing pair includes one slicing blade on the primary shaft and one slicing blade on the secondary shaft. The slicing blades in each slicing pair have peripheral portions that overlap each other. The apparatus further includes at least one biasing member for biasing the overlapping peripheral portions of the slicing blades of each slicing pair against each other.

According to another aspect, each of the slicing blades can have a circular configuration with a cutting edge that extends completely about its circumference.

According to another aspect, the apparatus can include gears mounted to and rotatable with the primary and secondary shafts so that rotation of the primary shaft in one direction imparts rotation of the secondary shaft in an opposite direction.

According to another aspect, the apparatus can include spacers for spacing the blades along the length of the primary and secondary shafts. The blades and spacers can be movable axially along the lengths of the primary and secondary shafts under the three applied by the at least one biasing member to permits the blades to be biased against each other.

According to another aspect, the primary and secondary shafts can have non-circular cross-sections that mate with openings in the blades so that the blades can slide axially along the length of its associated shaft but cannot rotate relative to its associated shaft.

According to another aspect, the apparatus can include bushings on the primary and secondary shafts for supporting the shafts for rotation in the housing.

According to another aspect, the apparatus can include a drive coupler mounted to the housing. The drive coupler can include an input coupling through which the primary shaft protrudes. The input coupling can be configured to be connected to an output coupling of a drive unit so that the drive unit can be operated to impart rotation of the primary and secondary shafts.

According to another aspect, the cutting edges of the blades of each slicing pair can cut partially though the food product from opposite sides of the meat so that the cuts formed by the blades or each slicing pair combine to form a complete slice through the meat.

According to another aspect, the apparatus can include combs positioned between the slicing pairs of blades to prevent food product slices from wrapping around the shafts during operation

According to another aspect, the biasing members can be coil springs.

According to another aspect, the apparatus can include two biasing members, one for biasing the blades associated with the primary shaft toward the blades associated with the secondary shaft, and one for biasing the blades associated with the secondary shaft toward the blades associated with the primary shaft.

According to another aspect, the blades can be configured to slide axially along the length of their associated shaft in response to the bias applied by the at least one biasing member.

### BRIEF DESCRIPTION OF THE DRAWINGS

For a better understanding of the invention, reference may be made to the accompanying drawings.

FIG. 1 is a side view of a prior art food processing apparatus including a grinder head.

FIG. 2 is a perspective view illustrating an apparatus for processing food products according to the invention.

FIG. 3 is an exploded perspective view of the apparatus of FIG. 2 in a first configuration.

FIG. 4 is an exploded perspective view of the apparatus of FIG. 2 in a second configuration.

FIG. 5 is a top view of a portion of the apparatus of FIG. 4.

FIG. 5A is a sectional view taken generally along line 5A-5A in FIG. 5.

### DESCRIPTION OF EMBODIMENTS

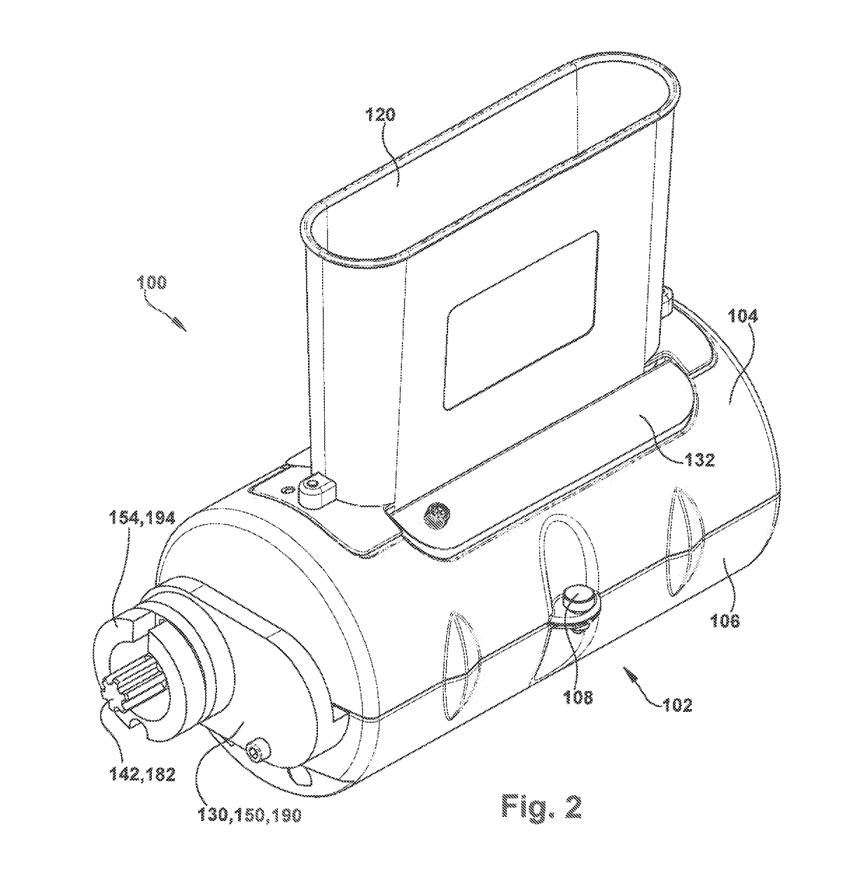

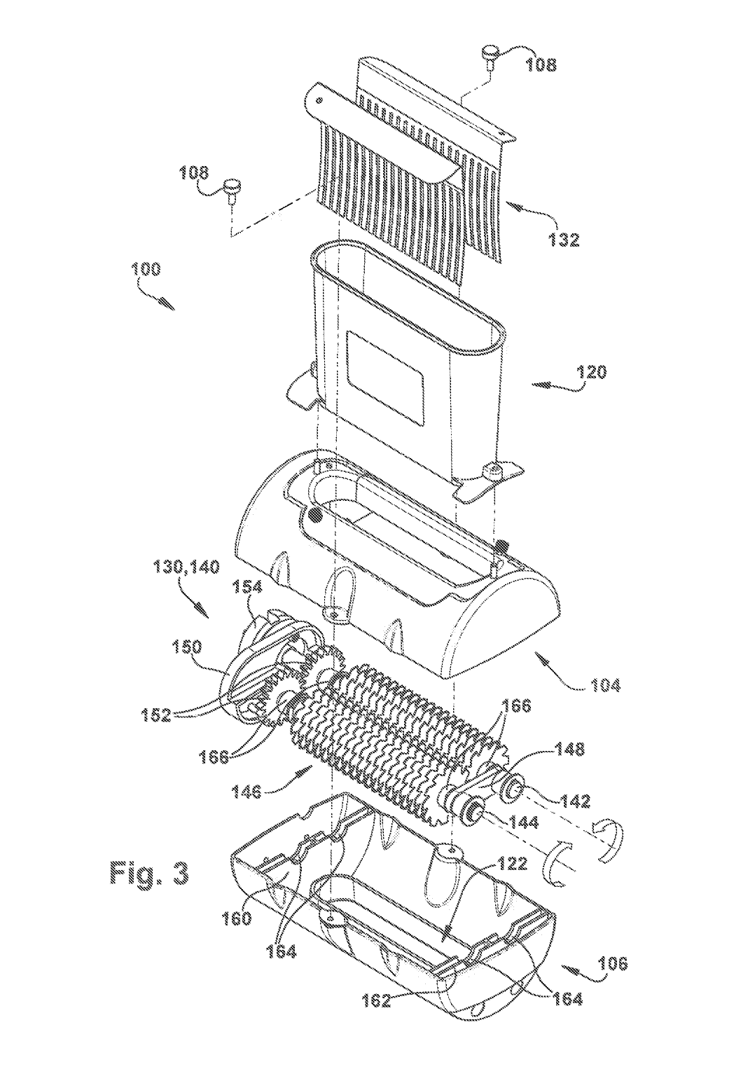

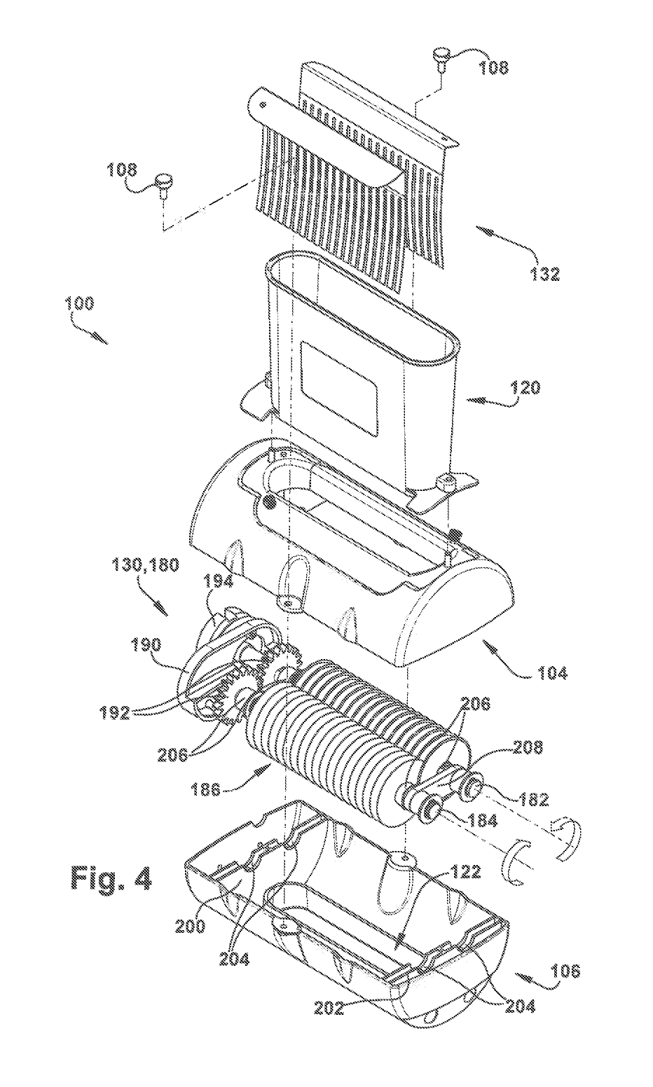

Referring to FIG. 2, according to the invention, an apparatus 100 for processing food products, and specifically for tenderizing and slicing meat. The apparatus includes a housing 102 including an upper housing part 104 and a lower housing part 106 that are connected to each other at least partially by one or more fasteners 108, such as thumb screws. The housing 102 includes an inlet chute 120 through which a meat product, such as a steak, can be fed, and an outlet opening 122 (see FIGS. 3 and 4) through which the processed meat exits the apparatus 100.

The apparatus 100 also includes one or more a meat processing portions 130 that are interchangeably received by and supported in the housing 102. In the embodiment of FIG. 3, the meat processing portion 130 is a tenderizer unit 140, and the apparatus 100 is therefore configured as a meat tenderizer. In the embodiment of FIG. 4, the meat processing portion 130 is a slicing unit 180 and the apparatus 100 is therefore configured as a meat slicer. The apparatus 100 further includes a pair of combs 132 that are insertable into the housing 102 and function to prevent meat from wrapping around blades of the meat processing portions 130, which are described below.

### Tenderizer

Referring to FIG. 3, the tenderizer unit 140 includes a primary shaft 142 and a secondary shaft 144, upon each of which is supported a plurality of tenderizing blades 146. The to blades 146 have the configuration or profile of a cog, including teeth with cutting edges at their ends. The cutting edges of the tenderizing blades 146 are segmented along the outer periphery of the blade due to the toothed configuration of the blade. The blades 146 are sized and positioned on the shafts 142, 144 so that they are arranged in pairs, with each pair including one blade from each shaft. The blade pairs are positioned close to each other and slightly overlap each other.

A linkage 148 at one end of the shafts 142, 144 and a drive coupler 150 at the other end of the shafts support the shafts for rotation about their respective axes while maintaining a spaced parallel relationship between the shafts. Gears 152 are mounted to the shafts 142, 144 and are positioned in mating engagement with each other such that rotation of the primary shaft 142 in one direction causes the secondary shaft 144 to rotate in an opposite direction.

The lower housing part 106 includes spaced pairs of inner walls 160, 162 that support the tenderizer unit 140 in the housing 102. The inner wails 160, 162 include recesses 164 for receiving the shafts 142, 144. The tenderizer unit 140 can include bearings or bushings 166 on the shafts 142, 144 for supporting the shafts in the recesses 164 and reducing friction. The upper housing part 108 includes similar or identical inner wails (not shown) with recesses mate with those of the lower housing part 106 and receive the shafts/bushings to fully support the tenderizer unit 140 in the housing 102.

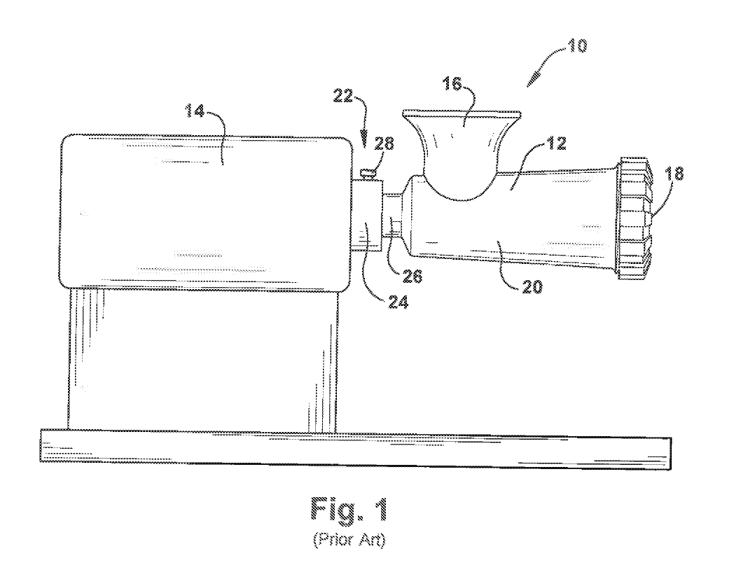

In the assembled condition shown in FIG. 2, the primary shaft 142 protrudes from an input coupling 154 of the drive coupler 150. The input coupling 154 is configured to be received in and connected to an output coupling of a drive unit, such as the output coupling 24 of the drive unit 14 illustrated in FIG. 1. In operation, the drive unit rotates the primary shaft 142 to rotate in a direction inward toward the secondary shaft 144, as indicated generally by the arrow in FIG. 3. In response to this rotation and the operation of the gears 152, the secondary shaft 144 rotates in an opposite direction, as indicated generally by the arrow in FIG. 3.

As meat is fed through the inlet chute 120, it reaches the tenderizer unit 140 and the rotating tenderizing blades 146. The toothed blades 146 “grab” onto the meat and draw it through the tenderizer unit between the blades. As this occurs, the segmented toothed blades 146 cut partially into and perforate the meat, which tenderizes it. The combs 132, being positioned between the blades 146, prevent the meat from wrapping around the shafts 142, 144 and thereby force the tenderized meat to be discharged through the outlet opening 122. While perforated and tenderized, the meat remains a single piece.

### Slicer

Referring to FIG. 4, the slicer unit 180 includes a primary shaft 182 and a secondary shaft 184, upon each of which is supported a plurality of slicing blades 186. The slicing blades 186 have the configuration or profile of a circle with a cutting edge that extends completely about its circumference. The blades 186 are sized and positioned on the shafts 142, 144 so that they are arranged in slicing pairs, with each pair including one blade from each shaft. The blades 186 in each slicing pair are positioned against or extremely close to each other and have outer peripheral portions that overlap each other to a greater extent than the tenderizer blades. This is because the slicing blades 186 must cut completely through the meat in order to form the strips, whereas tenderizing the meat requires only a partial cutting/perforation.

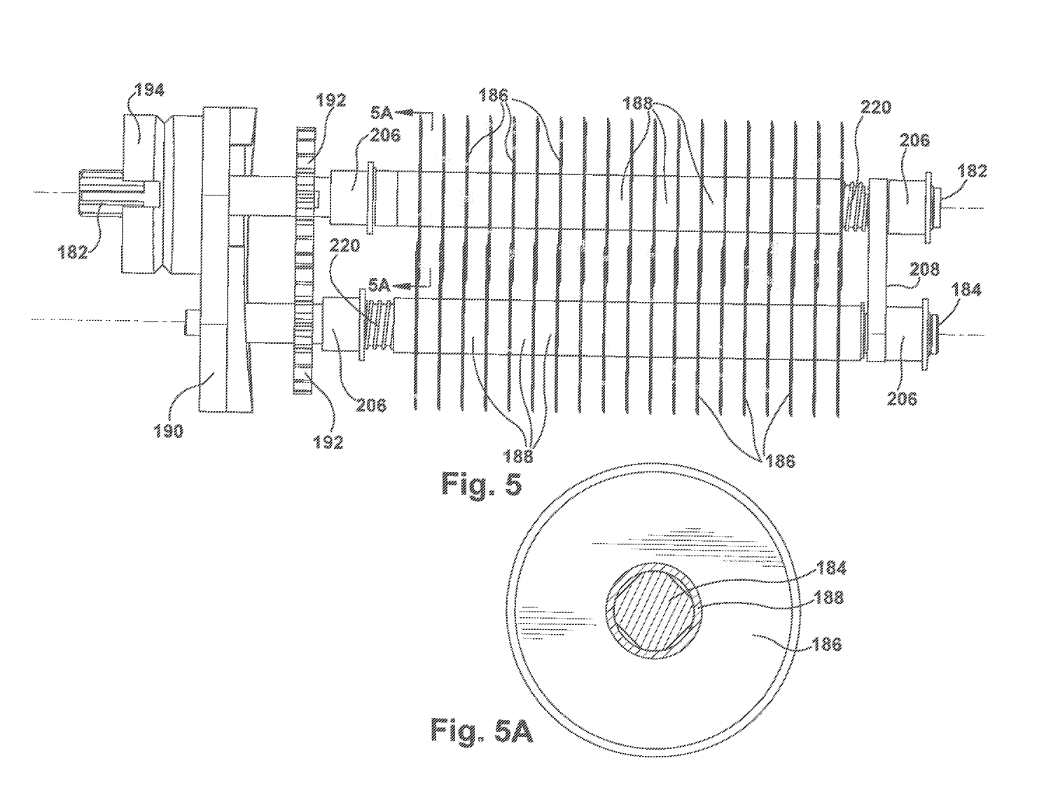

The blades 186 are spaced along the lengths of their respective shafts 182, 184 by spacers 188 that maintain their relative positions on the shaft. The blades 186 and spacers 188 are not fixed to the shaft. The blades 186 and spacers 188 can slide axially along the length of each shaft. The blades 186 can rotate with the shafts 182, 184 due to a non-circular, e.g., polygonal, hexagonal, octagonal, etc., configuration of the shafts (see detail in FIG. 5A).

This non-circular configuration of the shafts 182, 184 and the openings in the blades 186 and spacers 188 through which the shafts extend allows the blades to slide axially relatively to the shafts while preventing rotation of the blades relative to the shafts. Rotation of the shafts 182, 184 thus imparts a positive rotational drive on the blades 186. The spacers 188 can have a circular inner diameter (as shown) so that the spacers can both slide and rotate over the shafts 182, 184. The spacers 188 could have an inner configuration that mates with the shafts 182, 184 so that the spacers slide along the shaft and rotate with. the shaft in the same manner as the blades 186.

A linkage 208 at one end of the shafts 182, 184 and a drive coupler 190 at the other end of the shafts support the shafts for rotation about their respective axes while maintaining a spaced parallel relationship between the shafts. Gears 192 are mounted to the shafts 182, 184 and are positioned in mating engagement with each other such that rotation of the primary shaft 182 in one direction causes the secondary shaft 184 to rotate in an opposite direction.

The lower housing part 106 includes spaced pairs of inner walls 200, 202 that support the slicer unit 180 in the housing 102. The inner walls 200, 202 include recesses 204 for receiving the shafts 182, 184. The slicer unit 180 can include bearings or bushings 200 on the shafts 182, 184 for supporting the shafts in the recesses 204 and reducing friction. The upper housing part 104 includes similar or identical inner walls (not shown) with recesses mate with those of the lower housing part 106 and receive the shafts/bushings to fully support the slicer unit 180 in the housing 102.

In the assembled condition shown in FIG. 2, the primary shaft 182 protrudes from an input coupling 194 of the drive coupler 190. The input coupling 194 is configured to be received in and connected to an output coupling of a drive unit, such as the output coupling 24 of the drive unit 18 illustrated in FIG. 1. In operation, the drive unit rotates the primary shaft 182 to rotate in a direction inward toward the secondary shaft 184, as indicated generally by the arrow in FIG. 4. In response to this rotation and the operation of the gears 192, the secondary shaft 184 rotates in an opposite direction, as indicated generally by the arrow in FIG. 4.

As meat is fed through the inlet chute 120, it reaches the slicer unit 180 and the rotating slicing blades 186. The blades 186 draw the meat through the slicer unit between the blades. As this occurs, the cutting edges of the blades 186 of each slicing pair cut through and slice the meat into separated strips. In doing so, each blade 186 of cuts partially though the meat from Opposite sides of the meat, so that the cuts formed by the blades or each slicing pair combine to form a complete slice through the meat. The combs 132, being positioned between the blades 186, prevent the meat slices from wrapping around the shafts 182, 184 and thereby force the meat slices to be discharged through the outlet opening 122. The meat, sliced in this manner, can, for example, be used to make jerky.

In the meat slicer configuration of the apparatus 100, it is important that the blades 186 slice completely through the meat in order to produce strips of a consistent, uniform quality. Because each blade 186 in the slicing pair performs a portion of the cut, it is important that those two cuts coincide with or intersect each other, else the slice will not be completed. Ideally, the blades 186 in the slicing pairs should touch each other in order to ensure a complete slice. Any space between the blades 186 could result in spaced partial cuts, leaving a thin strip of meat connecting the adjacent slices. Constructing the apparatus 100 with low tolerances in order to maintain close contact between the blade pairs can be cost prohibitive. Because of this, spacing between the blades 186 of the slicing pairs can occur due to tolerance build-up or stacking.

Referring to FIG. 5, according to the present invention, the slicer unit 180 includes features that help ensure that adjacent blades 186 in the slicing pairs remain engaged with each other or as Close to each other as possible to help ensure complete, uniform slicing. Referring to FIG. 5, the slicer unit 180 includes one or more biasing members 220, such as coil springs, that bias the blades 186 associated with one or both of the shafts 182, 184 to slide along their respective shafts toward each other. As a result, the blades 186 in the slicing pairs can be maintained in abutting engagement with each other.

In the embodiment shown in FIG. 5, the slicer unit includes two biasing members 220, one associated with the primary shaft 182 and one associated with. the secondary shaft 184. The biasing members 220 are arranged to urge the blades 186 of the slicing pairs to slide along their respective shafts 182, 184 into engagement with each other. To accomplish this, the biasing member 220 associated with the primary shaft 182 biases the blades 186 associated with that shaft toward the drive coupler 190. The biasing member 220 associated with the secondary shaft 184 biases the blades 186 associated with that shaft away the drive coupler 190. If the overlap of the blades 186 of the slicing pairs was reversed, the direction of the bias applied by the biasing members 20 would also need reversed. It should be noted that the biasing applied by the biasing members 220 also causes the spacers 186 to move along the shaft 182, 184 to facilitate the sliding movement and engagement of the blades 186.

More specifically, in the embodiment illustrated in FIG. 5, the biasing member 220 associated with the primary shaft 182 is positioned between the blades 186 and the linkage 208. The biasing member 220 thus biases the blades 186 of the primary shaft 182 away from the linkage 208 toward the drive coupler 190. The biasing member 220 associated with the secondary shaft 184 is positioned between the blades 186 and the drive coupler 190. The biasing member 220 thus biases the blades 186 of the primary shaft 182 away from the drive coupler 190. Since the blades 186 of the slicing pairs are arranged with the blades of the secondary shaft 184 overlying the blades of the primary shaft 182, i.e., closer to the drive coupler 190, the biasing members 220 urge the blades of each slicing pair against each other.

While aspects of the present invention have been particularly shown and described with reference to the preferred embodiment above, it will be understood by those of ordinary skill in the art that various additional embodiments may be contemplated without departing from the spirit and scope of the present invention. Other aspects, objects, and advantages of the present invention can be obtained from a study of the drawings, the disclosure, and the appended claims.

Having described the invention, we claim:

1. An apparatus for slicing food products, comprising:
a housing including an inlet for receiving food products to be sliced, an outlet for discharging the sliced food product;
a primary shaft supported in the housing for rotation about a primary axis, the primary shaft carrying a plurality of slicing blades that are rotatable with the primary shaft about the primary axis;
a secondary shaft supported in the housing for rotation about a secondary axis, the secondary shaft carrying a plurality of slicing blades that are rotatable with the secondary shaft about the secondary axis;
wherein the primary and secondary shafts are positioned in the housing in a spaced and parallel manner so that the slicing blades are arranged in slicing pairs comprising one slicing blade on the primary shaft, and one slicing blade on the secondary shaft, and so that the slicing blades in each slicing pair have peripheral portions that overlap each other;
the apparatus further comprising at least one biasing member fear biasing the overlapping peripheral portions of the slicing blades of each slicing pair against each other.

2. The apparatus recited in claim 1, wherein each of the slicing blades have a circular configuration with a cutting edge that extends completely about its circumference.

3. The apparatus recited In claim 1, further comprising gears mounted to and rotatable with the primary and secondary shafts so that rotation of the primary shaft in one direction imparts rotation of the secondary shaft in an opposite direction.

4. The apparatus recited in claim 1, further comprising spacers for spacing the blades along the length of the primary and secondary shafts, the blades and spacers being movable axially along the lengths of the primary and secondary shafts under the force applied by the at least one biasing member to permits the blades to be biased against each other.

5. The apparatus recited in claim 1, wherein the primary and secondary shafts have non-circular cross-sections that mate with openings in the blades so that the blades can slide axially along the length of its associated shaft but cannot rotate relative to its associated shaft.

6. The apparatus recited in claim 1, further comprising bushings on the primary and secondary shafts for supporting the shafts for rotation in the housing.

7. The apparatus recited in claim 1, further comprising a drive coupler mounted to the housing, the drive coupler comprising an input coupling through which the primary shaft protrudes, the input coupling being configured to be connected to an output coupling of a drive unit so that the drive unit can be operated to impart rotation of the primary and secondary shafts.

8. The apparatus recited in claim 1, wherein the cutting edges of the blades of each slicing pair cut partially though the food product from opposite sides of the meat, so that the cuts formed by the blades or each slicing pair combine to form a complete slice through the meat.

9. The apparatus recited in claim 1, further comprising combs positioned between the slicing pairs of blades to prevent food product slices from wrapping around the shafts during operation

10. The apparatus recited in claim 1, wherein the biasing members comprise coil springs.

11. The apparatus recited in claim 1, wherein the apparatus includes two biasing members, one for biasing the blades associated with the primary shaft toward the blades associated with the secondary shaft, and one for biasing the blades associated with the secondary shaft toward the blades associated with the primary shaft.

12. The apparatus recited in claim 1, wherein the blades are configured to slide axially along the length of their associated shaft in response to the bias applied by the at least one biasing member.
